(19) United States
(12) Patent Application Publication
(10) Pub. No.: US 2008/0288447 A1
(43) Pub. Date: Nov. 20, 2008

(54) METHODS AND APPARATUS FOR IMPROVING PEER EFFICIENCY

(76) Inventor: Mark Thompson, Tempe, AZ (US)

Correspondence Address: THE NOBLITT GROUP, PLLC, 4800 NORTH SCOTTSDALE ROAD, SUITE 6000, SCOTTSDALE, AZ, 85251, US

(21) Appl. No.: 12/104,259

(22) Filed: Apr. 16, 2008

Related U.S. Application Data
(60) Provisional application No. 60/912,084, filed on Apr. 16, 2007.

(51) Int. Cl. G06F 17/30

(52) U.S. Cl. 707/2; 707/E17.017

(57) ABSTRACT

Methods and apparatus for transferring data according to various aspects of the present invention operate in conjunction with a peer-to-peer (p2p) network. For example, a system may receive a request for sources for acquiring a file segment. The system may identify a set of candidate sources for retrieving the file segment and assess a connectivity for at least one candidate source. The system may transmit an identifier to the requestor for the at least one candidate source according to the connectivity assessment.

### CROSS-REFERENCES TO RELATED APPLICATIONS

This application claims the benefit of U.S. Provisional Patent Application No. 60/912,084, filed Apr. 16, 2007.

### BACKGROUND OF INVENTION

Peer-to-peer (p2p) networks operate by using the bandwidth and processing capability of multiple interconnected peer computers to facilitate the transfer of information. To transfer a digital file via a p2p network, the file is divided into file segments. Some p2p networks split the file into a chronological series of similarly sized segments. Other p2p networks, however, may use different algorithms such that the file segments are created as hashes of multiple file segments, or created via a cryptographical function.

After the file has been divided into file segments, the file segments may be distributed among the p2p clients. Any p2p client hoping to retrieve a particular file from the p2p network may then retrieve the individual file segments from other p2p clients that have access to any of the file segments. Upon retrieving all of the file segments, the p2p client may recombine the file segments into the original file. By distributing the file segments through the p2p clients, a p2p network may provide improved file transfer performance relative to conventional client-server configurations utilizing a single server or group of servers to transfer a file to a client.

To provide the improved performance, the p2p network exploits the ability of many p2p clients to transfer the file segments among themselves. In many network configurations, full duplex communication via the various p2p clients may be attained. In other network configurations, however, some of the p2p clients may be unable to effectively or fully communicate with one another. For example, one p2p may be capable of sending communications to another p2p client, but unable to receive communications from that p2p client.

Limited communicative ability between particular p2p clients may result from many different causes. The network may have a fault such as broken or misconfigured hardware that limits communication. Network administrators may have implemented measures to control and/or limit a particular type of communication. Alternatively, an individual p2p client may unilaterally elect to limit its communicative ability. Such a limitation on the ability of the p2p clients to participate in full-duplex communications may negatively impact the performance of the p2p network.

### SUMMARY OF THE INVENTION

Methods and apparatus for transferring data according to various aspects of the present invention operate in conjunction with a peer-to-peer (p2p) network. For example, a system may receive a request for sources for acquiring a file segment. The system may identify a set of candidate sources for retrieving the file segment and assess a connectivity for at least one candidate source. The system may transmit an identifier to the requestor for the at least one candidate source according to the connectivity assessment.

### BRIEF DESCRIPTION OF THE DRAWING FIGURES

FIG. 1 is a block diagram of a data transfer system according to various aspects of the present invention;

FIG. 2 is a flow diagram of data transfer operations according to various aspects of the present invention.

Elements and steps in the figures are illustrated for simplicity and clarity and have not necessarily been rendered according to any particular sequence. For example, steps that may be performed concurrently or in a different order may be illustrated in the figures as a sequence to improve understanding of the described embodiments of the present invention.

Elements, operational features, applications and/or advantages are illustrated by certain exemplary embodiments recited in the disclosure. Representative elements, operational features, applications and/or advantages of the present invention reside in the details of construction and operation as more fully described or otherwise identified. The description may refer to the accompanying drawings, images, figures, etc., wherein like numerals (if any) refer to like parts throughout.

### DETAILED DESCRIPTION OF EXEMPLARY EMBODIMENTS

The present descriptions relate to exemplary embodiments of the invention and the inventor's conception of the best mode and are not intended to limit the scope, applicability or configuration of the invention in any way. Rather, the following description is intended to provide convenient illustrations for implementing various embodiments of the invention. Changes may be made in the function and/or arrangement of any of the elements described in the disclosed exemplary embodiments without departing from the spirit and scope of the invention.

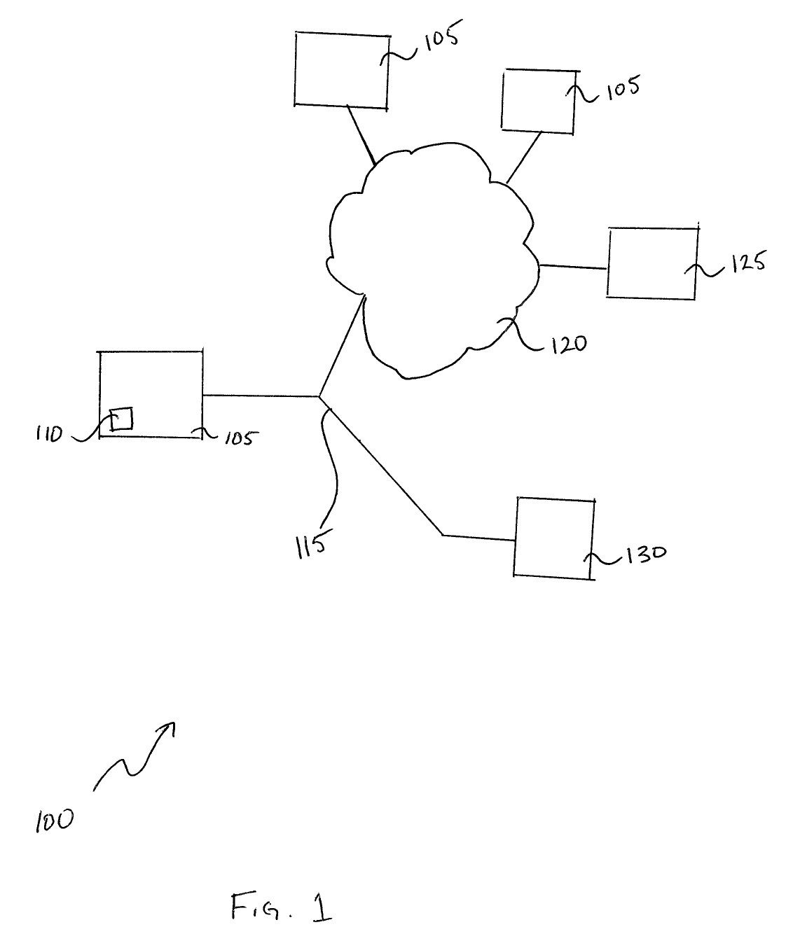

Referring to FIG. 1, a data transfer system 100 according to various aspects of the present invention may operate in conjunction with multiple computers exchanging data with improved peer efficiency. For example, the present exemplary data transfer system 100 comprises multiple p2p clients 105 connected to each other via one or more p2p networks 120, and one or more trackers 125. The data transfer system 100 may further include one or more servers 130. Data is transferred among the various p2p clients 105, trackers 125, and/or servers 130 via a communications medium 115.

The p2p clients 105 receive, store, and/or transmit information via the communications medium 115. The p2p clients 105 may comprise any suitable systems for communicating via a network and/or the communications medium 115. For example, one or more p2p clients 105 may comprise conventional computers having a processor and a storage mechanism, such as RAM, hard drives, CD-ROM drives and disks, HD-DVD drives and disks, or other appropriate volatile or non-volatile memory system. Alternatively, the p2p clients 105 may comprise a television, stereo, radio, telephone, PDA, personal media device, or other device that receives digital or analog data.

In the present embodiment, the p2p clients 105 request and/or provide information via the medium 115 and p2p networks 120. For example, the p2p clients 105 may comprise conventional computer systems that run operating systems, such as Microsoft Windows, Mac OSX, or Linux, and may execute software and connect to a network. The p2p clients 105 may connect to a network in any suitable manner, including via network cable connections or wireless connections. Also, the p2p clients 105 may communicate through the networks using any appropriate communication protocols, such as TCP/IP, UDP, etc. In the present embodiment, the p2p clients 105 request and provide information according to software applications. The information transfer functionality may be implemented in any suitable manner, however, such as via hard coding, firmware, or other technique.

In one embodiment, the p2p clients 105 operate a client application 110 to exchange data via the communications medium 115 and p2p networks 120. The client application 110 may comprise any software application or combination of software applications for requesting and/or receiving data via the communications medium 115 and p2p networks 120. For example, the client application 110 may retrieve descriptive data that describes a desired file to be retrieved via the p2p network 120. In the present embodiment, the descriptive data may comprise a conventional .torrent file that describes the file to be retrieved and provides additional data to facilitate its retrieval, and the client application 110 comprises a conventional BitTorrent client program.

For example, the file description data may describe the name of the file, its size, the size and number of file segments associated with the file, and the IP address of one or more trackers 125 that facilitate the file's distribution. The descriptive data may be obtained from any source, such as from the server 130 or another application running on the p2p client 105. In the present embodiment, the descriptive data comprises conventional descriptive data associated with a file for retrieval via p2p networks 120, such as a conventional .torrent file for identifying trackers 125 tracking the relevant file.

The client application 110 may use the descriptive data to connect to the p2p network 120 to retrieve segments of the file to be downloaded. While downloading a particular file from the p2p clients 105, the client application 110 may identify those file segments that have not yet been retrieved and may connect to other p2p clients 120 to retrieve those file segments. Furthermore, the client application 110 may request specific file segments to retrieve from the p2p network 120, for example for retrieving file segments in an approximately sequential order.

Upon retrieving file segments from the p2p network 120, the client application 110 may store the file segments in a location that is accessible to the p2p client 105 and/or other applications running on the p2p client 105. For example, the file segments may be stored on a local memory system such as a hard drive, RAM memory, or other suitable volatile or non-volatile memory system. Alternatively, the file segments may be stored on a remote memory system that is accessible to the p2p client 105 via the communications medium 115 and that does not physically reside within the p2p client 105 or in close proximity to the p2p client 105.

The client application 110 may further communicate with one or more trackers 125 of the p2p network 120, for example to permit the p2p network 120 to operate more efficiently. For example, the client application 110 may provide information to the trackers 125 associated with the client application's 110 performance and/or the performance of other clients 105 in the p2p network 120. The tracker 125 may store and/or process the information to improve the operation of the p2p network 120.

The client application 110 may provide any appropriate information about the client 105, other clients 105, and/or the p2p network 120, including information about file segments available to or from a particular p2p client 105, the ability of the p2p client 105 to communicate with other p2p clients 105, the type of client application 110 running on the p2p client 105, the Internet Protocol (IP) address and other network information of the p2p client 105, and the performance characteristics of any communication channel between the various p2p clients 105. Furthermore, the client application 110 may be configured to communicate with the tracker 125 to facilitate characterization of the communication channel between the p2p client 105 and the tracker 125.

In one embodiment, the client application 110 may transmit information regarding itself, such as identifiers of file segments it currently has available for distribution, the type of client application 110 running on the p2p client 105, the Internet Protocol (IP) address for the client application 110. The client application 110 may also transmit information regarding p2p network 120 performance and/or characterizing the communication channel with other peers, such as providing numbers of requests received and/or responded to for file segments and/or particular file segments, response times and results for requests submitted to other clients 105, results of previous attempts to request files from other clients, such as whether a particular client responded to a request and/or how quickly the response was received, or other information regarding the client application's 110 ability to communicate with other clients 105, generally and/or for specific other clients 105. In one embodiment, the client application provides information regarding the results of a preceding attempts to acquire file segments from other peer clients 105, such as identifiers of the clients 105 that responded with the requested file segments, those that responded without the file segments, those that did not respond at all, and/or those that could not be connected to. The information may also include other information, such as the size and speed of the data transfers or response times to the requests.

The communications medium 115 may comprise any suitable medium for transferring information. For example, the communications medium 115 may comprise the Internet or other suitable electronic network, such as a local area network.

In the present embodiment, the communications medium 115 facilitates operation of the p2p network 120, such as a BitTorrent p2p network, comprising multiple devices configured to exchange information, such as two or more computers that use the BitTorrent protocol to distribute digital files. The p2p network 120 may, however, comprise a network of computers using additional or alternative systems for communicating and distributing files among peers. The p2p clients 105 communicate via the p2p network 120 in conjunction with the trackers 125 such that the p2p clients 120 may retrieve file segments from other p2p clients 105 of the p2p network 120. Any appropriate system and device may be connected to the p2p network 120, such as computers, servers, entertainment systems, data sources, and other servers.

The data embodied within the file segments that are communicated via the communications medium 115 between the p2p clients 105 may comprise any suitable data capable of being communicated via the communications medium 115. For example, the data may comprise a single digital file or collection of files that may comprise documents, images, video files, music files, game files, or other collections of digital information. Alternatively, the data may comprise a stream of data embodying a video or music broadcast. The stream may comprise a quasi-continuous flow of data made available via the communications medium 115 and that may be distributed by the p2p clients 105 of the p2p network 115. In an alternate embodiment, the data may comprise analog information that may be distributed via the communications medium 115, for example comprising an analog video or music broadcast.

The trackers 125 facilitate communications between the p2p clients 105 of the p2p network 120, for example by identifying peer clients 105 from which file segments may be requested. The trackers 125 may comprise one or more conventional computers having a processor and a memory and/or applications running on such computers that communicate with the p2p clients 105 through the communications medium 115. In the present embodiment, each tracker 125 is adapted to maintain a list of p2p clients 105 distributing file segments corresponding to a particular file, like a conventional p2p network tracker, which may be forwarded in response to a request from a client 105.

In addition, the tracker 125 may process and/or provide additional information to improve the p2p network 120. For example, the tracker 125 may adjust the list of candidate clients 105 to be provided in response to a request, such as according to whether a particular candidate client is responding to the tracker 125 and/or other clients 105, anticipated response times of the candidate clients 105, and/or reliability of the candidate clients 105.

The tracker 125 may use any suitable algorithm that uses any combination of available data to select the list of available p2p clients 105 to transmit to a requesting p2p client 105. Available data may include information transmitted by each of the p2p clients 105 to the tracker 125, information about the tracker 125 or combination of trackers 125 themselves, characteristics of the file or group of files or file segments to be transferred, or pre-determined variables, such as a list of p2p clients 105 to always include in the list of available p2p clients 105. The tracker 125 may further adjust the list according to the characteristics of the individual p2p client 105 requesting the file segments, such as whether the requesting client 105 responds to requests or otherwise participates, and to what degree, in the p2p network 120.

In one embodiment, the tracker 125 may assess the desirability of a particular client 105 as a file segment source according to any criteria. For example, the tracker 125 may actively determine whether clients 105 are available for responding to requests, such as by periodically attempting to connect to the various candidate clients 105 and storing the results. Alternatively, the tracker 125 may operate as a dummy client 105 by requesting file segments from the various candidate clients 105 and noting the response, if any, from the particular client 105.

The tracker 125 may assess the desirability of a particular client 105 according to any appropriate information. For example, the tracker 125 may process information received from other clients 105 regarding communications and attempted communications with a particular candidate client 105. In one embodiment, the tracker 125 may determine that a particular candidate client is a less desirable or unsuitable source if a selected number of unfulfilled requests have been made to the candidate client 105, for example within a particular period.

In additional variations, the tracker 125 may only transmit identifiers of p2p clients 105 that are capable of full-duplex communication with the requesting p2p client 105. The tracker 125 may also list only those p2p clients 105 that have the requested file segments available. The tracker 125 may receive and/or use any relevant communications from the other p2p clients 105 relating to the performance of the p2p network and the client 105, and the tracker 125 may modify or otherwise adjust the list of p2p clients 105 for a particular file or file segment accordingly.

The server 130 may comprise any suitable computer system or group of systems configured to communicate via the medium 115. For example, the server 130 may comprise hardware, software, and/or networking components configured to receive and process requests from the p2p clients 105 and provide a suitable website or other Internet-based user interface which is accessible by the p2p clients 105. In one embodiment, the server 130 comprises a computer running an operating system (i.e. MS Windows, Mac OSX, Linux, etc.) and a web server (i.e. Apache, etc.). The server 130 is also capable of storing the descriptive data that describes the file that is to be delivered to the client application 110. In the present embodiment, the descriptive data to be retrieved from the server 130 may comprise a .torrent file that contains data describing the file and the one or more trackers 125 associated with the file. In various p2p network 120 implementations, the tracker 125 for a particular file may be conventionally identified, for example in a .torrent file that contains the address of the tracker.

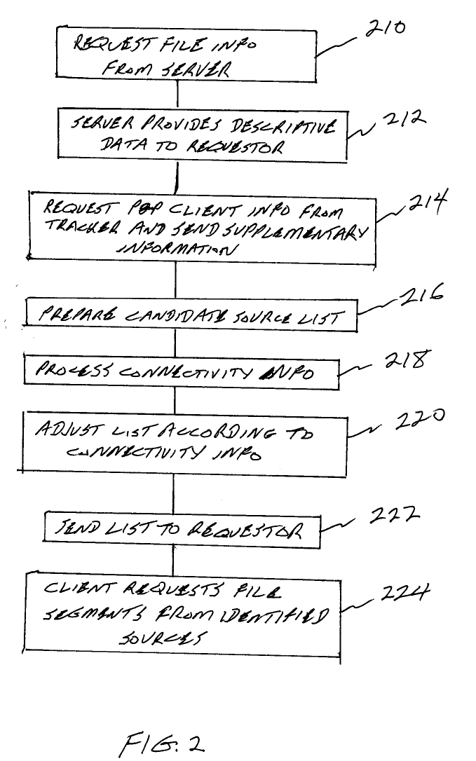

Referring to FIG. 2, a process for transferring data 200 may include transferring information in response to a request initiated by the client application 110. The request may comprise a communication transmitted from the p2p client 105 to the server 130 (210), for example in response to a user clicking on an image or otherwise designating a desired file. In response, the server 130 provides the descriptive data to the requesting client 105 (212). For example, the server 130 may provide information describing the file to be retrieved from the p2p network 120 and one or more trackers 125 maintaining lists of p2p clients 105 distributing segments of the file.

Upon receiving the descriptive data from the server 130, the p2p client 105 may contact one of the identified trackers 125 to retrieve a list of sources, such as p2p clients 105, distributing the relevant file segments (214). In one embodiment, the p2p client 105 transmits the request accompanied by supplementary information to the tracker 125. The supplementary information may describe the type of client application 110 running on the p2p client 105, the Internet Protocol (IP), and other network information of the p2p client 105. The supplementary information may include any other appropriate data, such as data relating to the performance of the p2p network 120.

In the present embodiment, the supplementary information may include an assessment of the performance of the p2p network 120, such as connectivity information for various clients 105 in the p2p network 120. The connectivity information may comprise any information relating to whether and how well the p2p network 120 elements can communicate with a particular client 105 or group of clients 105. In one embodiment, the client 105 provides information regarding which clients 105 were previously contacted with requests for file segments and whether the clients 105 responded. The p2p network 120 performance information may be associated with any requests or period of time, such as requests over a particular time period (e.g., in the last hour) or particular number (e.g., the last one or five attempts to download files).

In response, the tracker 125 may provide data regarding potential sources for the file segments, such as a list identifying available p2p clients 105 that are distributing relevant segments of the file. In the present embodiment, upon receiving the request data from the p2p client 105, the tracker 125 may formulate a list of candidate sources, such as p2p clients 105 with which the p2p client 105 may communicate (216). The tracker 125 may use any suitable algorithm and any available information in forming and adjusting the list.

As new p2p clients 105 join the p2p network 120 and as p2p clients 105 leave the network, the tracker 125 may update its list of available p2p clients 105. The tracker 125 may inform p2p clients 105 of suitable p2p clients 105 with which to communicate, for example in response to requests for files. The tracker 125 may also maintain a list of file segments that are available on each p2p client 105. In the present embodiment, the tracker 125 may continuously monitor and update the lists of available p2p clients 105 for each individual p2p client 105, for example based on attempts to connect to the clients 105 by the tracker 125 or according to information about particular clients 105 received from other clients.

For example, the tracker 125 may assess the connectivity of the various clients 105 (218) and modify the list of clients 105 according to the connectivity of the various clients (220). In one embodiment, the tracker 125 may continuously or periodically monitor whether a particular p2p client 105 is responding to requests for file segments, for example by attempting to connect to the client 105 or requesting a file segment from each p2p client 105. Based upon the results of the tests, the tracker 125 may modify the list of suitable p2p clients 105 for each p2p client 105. If the tracker 125 cannot connect to a particular client 105 or otherwise determines that the client 105 cannot or will not respond to a request for a particular file, the tracker 125 may omit the non-responsive client 105 from the list.

In a further alternate embodiment, the tracker 125 may assess the connectivity of particular clients 105 according to information provided by the p2p clients 105. For example, each p2p client 105 may transmit to the tracker 125 a list of p2p clients 105 to which file segments have been successfully transmitted and/or a list of p2p client 105 from which file segments have been successfully retrieved. Based upon this information, the tracker 125 may generate a list of p2p clients 105 that is optimized such that a maximum number of p2p clients 105 of the p2p network 120 are capable of transmitting file segments among themselves.

In an alternative embodiment, the tracker 125 may only generate a single list of suitable p2p clients 105 based upon information initially transferred to the tracker 125 by each p2p client 105. As the list is updated to add new clients 105 based upon such information, the tracker 125 may distribute updated lists of p2p clients 105 to other clients 105 in the p2p network 120 so that each p2p client 105 has recent information regarding p2p network 120 resources. The tracker 125 may send the updates at regular intervals or in response to events, such as the addition of a new client 105.

Upon creation of the list, the tracker 125 may then communicate that list to the p2p client 105 (222). After receiving the list of suitable p2p clients 105, the p2p client 105 may then communicate with the p2p clients 105 on the list and begin retrieving file segments (224). In the present embodiment, the p2p clients 105 may use various BitTorrent protocols to communicate with other p2p clients 105 to retrieve appropriate file segments. While downloading a particular file from the p2p network 120, the client application 110 may identify those file segments that have not yet been retrieved and may connect to other clients 105 to retrieve those file segments.

In the foregoing specification, the invention has been described with reference to specific exemplary embodiments. Various modifications and changes may be made without departing from the scope of the present invention as set forth in the exemplary embodiments. The specification and figures are to be regarded in an illustrative manner, rather than a restrictive one and all such modifications may be included within the scope of the present invention. For example, the steps recited in any method or process embodiments may be executed in any appropriate order and are not limited to the specific order presented in the embodiments. Additionally, the components and/or elements recited in any apparatus embodiment may be otherwise assembled or operationally configured to produce substantially the same result and are accordingly not limited to the specific configurations recited in the embodiments.

Various benefits, advantages, and solutions to problems have been described with regard to particular embodiments. Any benefit, advantage, solution to problems or any element that may cause any particular benefit, advantage, or solution to occur or to become more pronounced are not to be construed as critical, required, or essential features or components of any or all the embodiments.

Elements in the figures, drawings, images, etc. are illustrated for simplicity and clarity and have not necessarily been drawn to scale. For example, the dimensions of some of the elements in the figures may be exaggerated relative to other elements to help improve understanding of various embodiments of the present invention. Furthermore, the terms ‘first’, ‘second’, and the like herein, if any, are used for distinguishing between similar elements and not necessarily for describing a sequential or chronological order. Moreover, the terms ‘front’, ‘back’, ‘top’, ‘bottom’, ‘over’, ‘under’, and the like in the disclosure and/or in the provisional embodiments, if any, are generally employed for descriptive purposes and not necessarily for comprehensively describing exclusive relative position. Any of the preceding terms so used may be interchanged under appropriate circumstances such that various embodiments of the invention, for example, are capable of operation in configurations and/or orientations other than those explicitly illustrated or otherwise described.

The terms “comprises”, “comprising”, “including”, or any variation thereof, are intended to reference a non-exclusive inclusion, such that a process, method, article, composition, or apparatus that comprises one or more elements does not include only the elements recited, but may also include other elements not expressly listed or inherent to such process, method, article, composition or apparatus. Other combinations and/or modifications of the described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the disclosed invention.

1. A computer-implemented method for transferring data via a peer-to-peer network to a requester, comprising:
receiving from the requestor a request for sources for acquiring a file segment;
identifying a set of candidate sources for retrieving the file segment;
assessing a connectivity for at least one candidate source; and
transmitting an identifier to the requestor for the at least one candidate source according to the connectivity assessment.

2. A computer-implemented method for transferring data according to claim 1, wherein assessing the connectivity comprises attempting to connect to the at least one candidate source.

3. A computer-implemented method for transferring data according to claim 1, wherein assessing the connectivity comprises requesting a file segment from the at least one candidate source.

4. A computer-implemented method for transferring data according to claim 1, wherein assessing the connectivity comprises:
receiving connectivity information for the at least one candidate source from other candidate sources relating to whether the at least one candidate source is responding to requests for file segments; and
assessing the connectivity of the at least one candidate source according to the connectivity information from the other candidate sources.

5. A computer-implemented method for transferring data according to claim 1, further comprising receiving network performance information from the requester, wherein assessing the connectivity for the at least one candidate source includes assessing the connectivity according to the network performance information.

6. A computer-implemented method for transferring data according to claim 5, wherein the network performance information relates to whether the at least one candidate source has responded to prior communications.

7. A computer-implemented method for transferring data according to claim 1, wherein transmitting the identifier for the at least one candidate source comprises transmitting the identifier only if the at least one candidate source is enabled to transmit and respond to file segment requests.

8. A computer for facilitating data transfer to a requesting client from another source on a peer-to-peer network, comprising:
a memory; and
a processor, wherein the processor is adapted to:
receive a request from the requesting client for sources for acquiring a file segment;
identify a set of candidate sources for retrieving the file segment;
assess a connectivity for at least one candidate source; and
transmit an identifier to the requesting client for the at least one source according to the connectivity assessment.

9. A computer according to claim 8, wherein the processor is adapted to assess the connectivity by attempting to connect to the at least one candidate source.

10. A computer according to claim 8, wherein the processor is adapted to assess the connectivity by requesting a file segment from the at least one candidate source.

11. A computer according to claim 8, wherein the processor is adapted to assess the connectivity by:
receiving connectivity information for the at least one candidate source from other candidate sources relating to whether the at least one candidate source is responding to requests for file segments; and
assessing the connectivity of the at least one candidate source according to the connectivity information from the other candidate sources.

12. A computer according to claim 8, wherein the processor is further adapted to receive network performance information from the requesting client, wherein assessing the connectivity for the at least one candidate source includes assessing the connectivity according to the network performance information.

13. A computer according to claim 12, wherein the network performance information relates to whether the at least one candidate source has responded to prior communications.

14. A computer according to claim 8, wherein the processor is adapted to transmit the identifier for the at least one candidate source by transmitting the identifier only if the at least one candidate source is enabled to transmit and respond to file segment requests.

15. A medium storing instructions executable by a machine, wherein the instructions cause the machine to execute a method for transferring data via a peer-to-peer network to a requestor, comprising:
receiving from the requestor a request for sources for acquiring a file segment;
identifying a set of candidate sources for retrieving the file segment;
assessing a connectivity for at least one candidate source; and
transmitting an identifier to the requestor for the at least one candidate source according to the connectivity assessment.

16. A medium according to claim 15, wherein assessing the connectivity comprises attempting to connect to the at least one candidate source.

17. A medium according to claim 15, wherein assessing the connectivity comprises requesting a file segment from the at least one candidate source.

18. A medium according to claim 15, wherein assessing the connectivity comprises:
receiving connectivity information for the at least one candidate source from other candidate sources relating to whether the at least one candidate source is responding to requests for file segments; and
assessing the connectivity of the at least one candidate source according to the connectivity information from the other candidate sources.

19. A medium according to claim 15, wherein the method further comprises receiving network performance information from the requester, wherein assessing the connectivity for the at least one candidate source includes assessing the connectivity according to the network performance information.

20. A medium according to claim 19, wherein the network performance information relates to whether the at least one candidate source has responded to prior communications.

21. A medium according to claim 15, wherein transmitting the identifier for the at least one candidate source comprises transmitting the identifier only if the at least one candidate source is enabled to transmit and respond to file segment requests.

22. A computer-readable program for transferring data via a peer-to-peer network to a requestor, the computer readable program adapted to cause a computer to:
receive from the requester a request for sources for acquiring a file segment;
identify a set of candidate sources for retrieving the file segment;
assess a connectivity for at least one candidate source; and
transmit an identifier to the requestor for the at least one candidate source according to the connectivity assessment.

23. A computer-readable program according to claim 22, wherein the computer readable program is adapted to cause a computer to assess the connectivity by attempting to connect to the at least one candidate source.

24. A computer-readable program according to claim 22, wherein the computer readable program is adapted to cause a computer to assess the connectivity by requesting a file segment from the at least one candidate source.

25. A computer-readable program according to claim 22, wherein the computer readable program is adapted to cause a computer to assess the connectivity by:
receiving connectivity information for the at least one candidate source from other candidate sources relating to whether the at least one candidate source is responding to requests for file segments; and
assessing the connectivity of the at least one candidate source according to the connectivity information from the other candidate sources.

26. A computer-readable program according to claim 22, wherein the computer readable program is further adapted to cause a computer to receive network performance information from the requestor, and assess the connectivity for the at least one candidate source by assessing the connectivity according to the network performance information.

27. A computer-readable program according to claim 26, wherein the network performance information relates to whether the at least one candidate source has responded to prior communications.

28. A computer-readable program according to claim 22, wherein the computer readable program is adapted to cause a computer transmit the identifier for the at least one candidate source by transmitting the identifier only if the at least one candidate source is enabled to transmit and respond to file segment requests.
